(19) United States
(12) Patent Application Publication
(10) Pub. No.: US 2026/0285350 A1
(43) Pub. Date: Sep. 24, 2026

(54) DRIVING ASSISTANCE APPARATUS AND PROGRAM PRODUCT

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Sae SUZUKI, Tokyo (JP); Tomohiko INOUE, Tokyo (JP); Rintaro HARIMA, Okazaki-shi (JP)

(21) Appl. No.: 19/567,705

(22) Filed: Mar. 16, 2026

(30) Foreign Application Priority Data
Mar. 18, 2025 (JP) 2025-043903

(51) Int. Cl. B60W 50/14; B60W 30/18; G06V 20/58

(52) U.S. Cl. CPC B60W 50/14; B60W 30/18159; G06V 20/584; B60W 2555/60

(57) ABSTRACT

In a driving assistance apparatus for a host vehicle, a driving assistance controller executes a driving assistance process of the host vehicle in response to recognizing a transition of a traffic signal to an arrow-signal indication state that includes a red signal and an arrow signal. A determiner determines, in response to new recognition of a current arrow-signal indication state of the traffic signal after execution of the driving assistance process, whether the arrow-signal indication state related to execution of the driving assistance process has continued unchanged in the current arrow-signal indication state. The driving assistance controller prevents execution of the driving assistance process of the host vehicle in response to the new recognition of the current arrow-signal indication state upon determination that the arrow-signal indication state related to execution of the driving assistance process has continued unchanged in the current arrow-signal indication state.

### CROSS-REFERENCE TO RELATED APPLICATION

This present application is based on and claims the benefit of priority from Japanese Patent Application No. 2025-043903 filed on Mar. 18, 2025, the disclosure of which is incorporated herein by reference.

### TECHNICAL FIELD

The present disclosure relates to a driving assistance apparatus and a program product.

### BACKGROUND

A known driving assistance process detects a change in the lighting state of a traffic light located in front of a host vehicle and notifies the change to the driver of the host vehicle.

For example, Japanese Patent Application Publication No. 2006-92129 discloses a driving assistance apparatus that executes, as a driving assistance process, issuance of a voice notification when detecting that the instruction of a traffic signal ahead of a stopped host vehicle changes from prohibiting starting to permitting starting. To suppress discomfort to the driver, the driving assistance apparatus refrains from providing the notification when detecting (i) no other vehicles within a predetermined range behind the host vehicle, (ii) an occupant in the front passenger seat of the host vehicle, or (iii) that the driver is holding the steering wheel.

### SUMMARY

Let us consider a situation where the host vehicle is waiting at an intersection with an arrow-type traffic signal. In this situation, when identifying the simultaneous illumination of a red light and an arrow light of the traffic signal, the driving assistance apparatus provides, to the driver of the host vehicle, the notification indicative of a proceed permission of the host vehicle in the direction indicated by the arrow light.

After the red light and the arrow light of the traffic signal are recognized by the driving assistance apparatus, there may occur a temporary lost state in which the traffic signal is obscured by another vehicle crossing in front of the host vehicle or another vehicle waiting in front of the host vehicle. In such a case, when the temporary lost state of the traffic signal is resolved and the same arrow light state as before the lost state (i.e., the red light and the arrow light) is recognized again, the driving assistance apparatus may erroneously determine that the lighting state of the traffic signal has changed to the red light and the arrow light, and erroneously execute, as a driving assistance process, issuance of a notification indicating a proceed permission of the host vehicle.

The issuance of such an unnecessary notification indicating a proceed permission of the host vehicle may cause the driver to feel discomfort or a sense of incongruity.

In view of the above circumstances, the present disclosure seeks to provide driving assistance apparatuses and program products, each of which is capable of preventing execution of an unnecessary driving assistance process.

An exemplary aspect of the present disclosure provides a driving assistance apparatus for a host vehicle in response to a traffic signal that is located in front of the host vehicle and includes a main signal unit and an arrow signal unit. The driving assistance apparatus includes a driving assistance controller configured to execute a driving assistance process of the host vehicle in response to recognizing a transition of the traffic signal to an arrow-signal indication state that includes a red signal and an arrow signal. The driving assistance apparatus includes a determiner configured to determine, in response to new recognition of a current arrow-signal indication state of the traffic signal after execution of the driving assistance process, whether the arrow-signal indication state related to execution of the driving assistance process has continued unchanged in the current arrow-signal indication state. The driving assistance controller is configured to prevent execution of the driving assistance process of the host vehicle in response to the new recognition of the current arrow-signal indication state upon determination that the arrow-signal indication state related to execution of the driving assistance process has continued unchanged in the current arrow-signal indication state.

The driving assistance controller of the driving assistance apparatus is configured to execute a driving assistance process of the host vehicle in response to recognizing a transition of the traffic signal to an arrow-signal indication state that includes a red signal and an arrow signal.

After the transition of the traffic signal to the arrow-signal indication state at least the arrow signal unit of the traffic signal may be lost. Immediately after resolution of the lost state, the driving assistance process may be unnecessarily executed in response to new recognition of a current arrow-signal state of the arrow signal unit even though the current arrow-signal state is identical to that before the occurrence of the lost state so that the driving assistance process based on the arrow-signal indication state related to execution of the driving assistance process has already been executed.

From this viewpoint, the driving assistance apparatus is configured to determine, in response to new recognition of a current arrow-signal indication state of the traffic signal after execution of the driving assistance process, whether the arrow-signal indication state related to execution of the driving assistance process has continued unchanged in the current arrow-signal indication state. The driving assistance apparatus is configured to prevent execution of the driving assistance process of the host vehicle in response to the new recognition of the current arrow-signal indication state upon determination that the arrow-signal indication state related to execution of the driving assistance process has continued unchanged in the current arrow-signal indication state.

This configuration therefore refrains from executing such an unnecessary driving assistance process, making it possible to appropriately execute driving assistance of the host vehicle.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating a configuration of a driving assistance system of a host vehicle;

FIG. 2 is a view schematically illustrating a traffic signal installed at an intersection;

FIG. 3 is a diagram illustrating an example of lighting state transitions created by a main signal unit and an arrow signal unit of the traffic signal;

FIG. 4 is a diagram illustrating an example of lighting state transitions created by the main signal unit and the arrow signal unit of an alternative arrow-type traffic signal;

Each of FIGS. 5A to 5C is a diagram illustrating a corresponding example of how to control notification of a proceed permission of the host vehicle in a case where a lost state of the traffic signal occurs;

FIG. 6 is a flowchart illustrating a driving-assistance control routine; and

FIG. 7 is a flowchart illustrating a modified driving-assistance control routine.

### DETAILED DESCRIPTION OF EMBODIMENTS

The following describes an embodiment of a driving assistance apparatus of the present disclosure with reference to accompanying drawings. In the present embodiment, a driving assistance system is configured to provide driving assistance for a vehicle, such as a passenger car, a truck, or a bus.

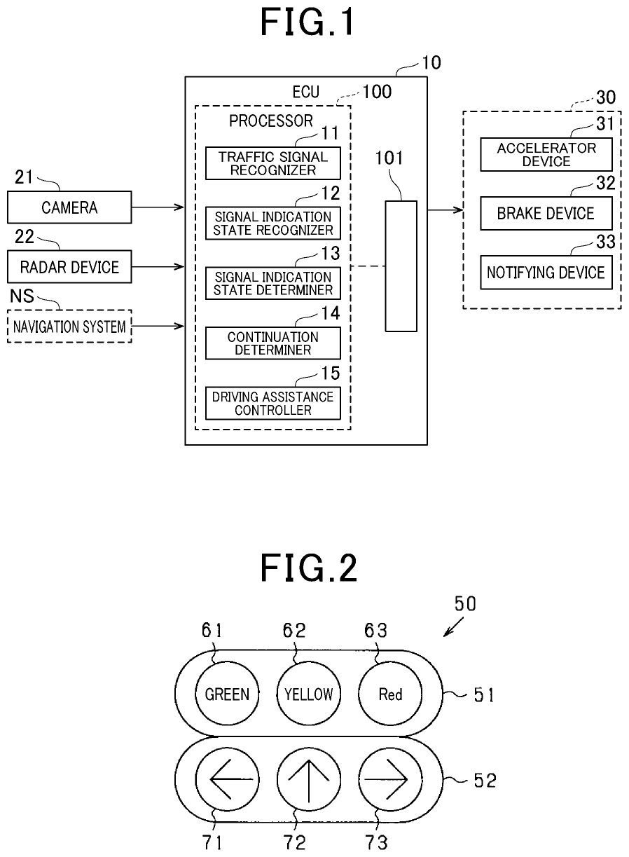

Referring to FIG. 1, the driving assistance system according to the present embodiment includes an electronic control unit (ECU) 10 serving as the driving assistance apparatus of the present embodiment, a camera 21, radar devices 22, and controlled devices 30 that include an accelerator device 31, a brake device 32, and a notifying device 33.

The camera 21 is an in-vehicle camera, such as a known CCD camera. The camera 21 is mounted to an upper portion of the inner surface of the front windshield of the vehicle (host vehicle), and configured to capture images of a predetermined region located in front of the host vehicle. The camera 21 is configured to successively capture images of the predetermined region at predetermined time intervals (periods), and successively transmit the captured images to the ECU 10 at predetermined periods. Each image captured by the camera 21 is comprised of pixel values (i.e., light-intensity values), where each pixel value includes information regarding both color and luminance. The camera 21 may be a monocular camera or a stereo camera.

Each radar device 22 is a distance measuring device using millimeter-wave high-frequency signals as transmitted waves. The radar devices 22 are mounted to, for example, the front and rear ends of the host vehicle. Each radar device 22 includes a plurality of antennas, and is configured to transmit a probe wave at predetermined periods through at least one transmission antenna included in the antennas and receive, through receiving antennas included in the antennas, reflected waves (echoes) resulting from reflection of the probe waves by an object. Then, each radar device 22 is configured to measure a distance to the object in accordance with a transmission timing of the probe wave and a reception timing of at least one of the reflected waves. Additionally, each radar device 22 is configured to calculate an azimuth of the object with respect to the corresponding radar device 22 based on phase differences among the reflected waves received through the receiving antennas. Calculating the distance to the object and the azimuth of the object enables a relative position of the object with respect to the host vehicle to be identified.

The ECU 10 includes a microcomputer provided with a processor, i.e., a CPU, 100 and a storage 101 including, for example, a RAM, a ROM, and a non-volatile rewritable memory. The microcomputer, i.e., the processor 100, provides various computing functions. Specifically, the processor 100 reads and executes computer programs, i.e., computer-program instructions, stored in the storage 101, such as the corresponding ROM or the non-volatile rewritable memory. Each of the ROM and the non-volatile rewritable memory serves as a non-transitory tangible storage medium. The programs include, for example, a program that causes the processor 100 to execute an object recognition process of recognizing one or more objects around the host vehicle, and a program that causes the processor 100 to execute a collision avoidance process of avoiding a collision of the host vehicle with objects and/or a collision mitigation process of mitigating damage in collision of the host vehicle with an object. The processor 100, which executes the programs, enables execution of corresponding respective methods. The programs stored in the storage 101 may be updated through a network, such as the Internet.

The ECU 10 acquires the captured images from the camera 21 and radar-related information from the radar devices 22, and recognizes at least one object around the host vehicle based on the acquired information. For example, the ECU 10 obtains image-related information including a distance and an azimuth of at least one image-based object based on the captured images. Then, the ECU 10 fuses the image-related information and the radar-related information that includes information related to the distance and the azimuth of at least one radar-based object measured by at least one of the radar devices 22, thus recognizing at least one object around the host vehicle.

The ECU 10 executes, based on information on the at least one recognized object around the host vehicle, driving assistance control of controlling at least one of the accelerator device 31, the brake device 32, and the notifying device 33. The accelerator device 31 is, for example, an engine and at least one motor for generating driving force of the host vehicle. That is, the ECU 10 controls at least one of the accelerator device 31 and the brake device 32 to accordingly control the driving state, i.e., the running state, of the host vehicle.

The notifying device 33 includes, for example, an audio device for notifying audio information and a display device for notifying visual information. The ECU 10 instructs, based on the driving state of the host vehicle, the notifying device 33 to notify various information, such as a warning, for the purpose of danger avoidance and/or driving assistance of the host vehicle.

The ECU 10 of the present embodiment is configured to execute, as the driving assistance control of the host vehicle, a process of determining whether to notify a proceed permission of the host vehicle in accordance with recognition information on a traffic signal located in front of the host vehicle.

More specifically, the ECU 10 is configured to recognize an arrow-signal indication state of an arrow-type traffic signal located in front of the host vehicle, and execute a control process related to notification of a proceed permission of the host vehicle in accordance with the recognized arrow-signal indication state of the arrow-type traffic signal.

The following describes the control process related to notification of a proceed permission of the host vehicle.

FIG. 2 is a view schematically illustrating a traffic signal 50 installed at an intersection.

The traffic signal 50 is an arrow-type traffic signal including a main signal unit 51 and an arrow signal unit 52. The main signal unit 51 includes a green signal unit (green lamp unit) 61, a yellow signal unit (yellow lamp unit) 62, and a red signal unit (red lamp unit) 63 arranged, for example, horizontally. The arrow signal unit 52 is an auxiliary signal unit that displays green arrow signals, and includes a left-turn arrow signal unit 71, a straight-ahead arrow signal unit 72, and a right-turn arrow signal unit 73 arranged, for example, horizontally. The arrow signal unit 52 provides an arrow signal indication that permits vehicles to proceed in the direction indicated by the arrow at the intersection, regardless of whether the main signal unit 51 is displaying the yellow signal or the red signal.

In the present disclosure, an arrow signal (arrow signal indication), such as a green arrow signal, refers to a signal that permits a vehicle to proceed in a direction indicated by the arrow, regardless of a state of a main signal (main signal indication).

Accordingly, in the present disclosure, a combination of a red signal of the main signal unit 51 and an arrow signal of the arrow signal unit 52 may indicate permission to proceed in a direction indicated by the arrow.

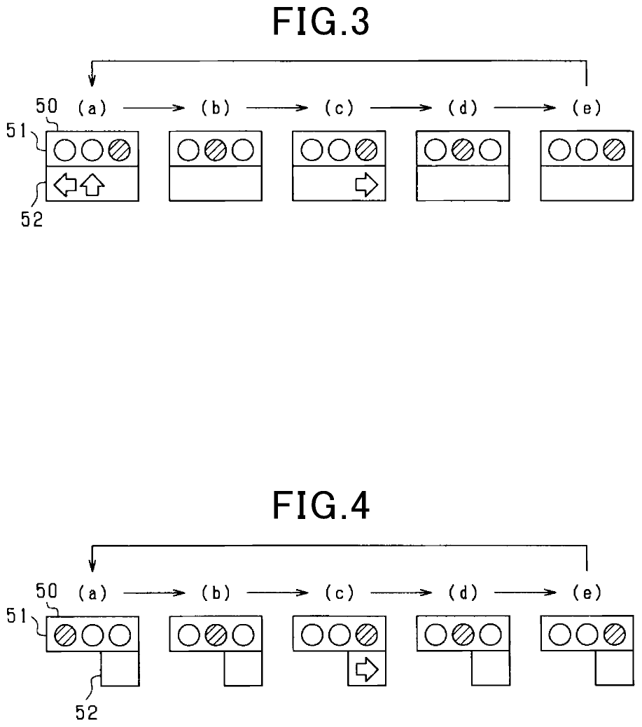

FIG. 3 illustrates an example of lighting state transitions created by the main signal unit 51 and the arrow signal unit 52 of the traffic signal 50. In FIG. 3, the traffic signal 50 changes sequentially in the order of an indication pattern (a) to an indication pattern (e).

The indication pattern (a) shows a red-signal indication together with left-turn and straight-ahead arrow signal indications in which the red signal is displayed by the main signal unit 51 and the left-turn arrow signal and the straight-ahead arrow signal are displayed by the arrow signal unit 52.

The indication pattern (b) shows a yellow-signal indication in which the yellow signal is displayed by the main signal unit 51.

The indication pattern (c) shows a red-signal indication together with a right-turn arrow signal indication in which the red signal is displayed by the main signal unit 51 and the right-turn arrow signal is displayed by the arrow signal unit 52.

The indication pattern (d) shows the yellow-signal indication in which the yellow signal is displayed by the main signal unit 51.

The indication pattern (e) shows the red-signal indication in which the red signal is displayed by the main signal unit 51.

After the indication pattern (e), the lighting state of the traffic signal 50 returns to the indication pattern (a).

Among the indications patterns FIG. 3(a) to FIG. 3(e), the indication patterns FIG. 3(a) and FIG. 3(c) correspond to arrow signal indication states, each of which includes a red-signal indication together with a corresponding arrow-signal indication.

As the traffic signal of the present embodiment, an alternative arrow-type traffic signal 50 may be used, which includes an arrow signal unit 52 that includes only the right-turn arrow signal unit 73.

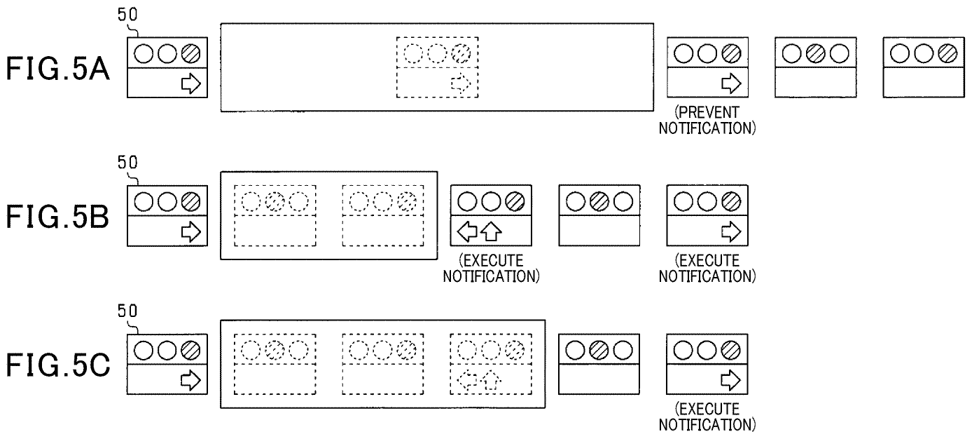

FIG. 4 illustrates an example of lighting state transitions created by the main signal unit 51 and the arrow signal unit 52 of the alternative arrow-type traffic signal 50. In FIG. 4, the alternative arrow-type traffic signal 50 changes sequentially in the order of an indication pattern (a) to an indication pattern (e).

The indication patterns FIG. 4(a) to 4(e) are substantially identical to the indication patterns FIG. 3(a) to 3(e) except that the indication pattern FIG. 4(a), which differs from that the indication pattern FIG. 3(a), shows the green-signal indication.

Among the indications patterns FIG. 4(a) to FIG. 4(e), the indication pattern FIG. 4(c) corresponds to an arrow-signal indication state including a red-signal indication together with a corresponding arrow-signal indication.

The ECU 10 is additionally configured to execute, as the driving assistance control of the host vehicle, a process of notifying, using the notifying device 33, that the host vehicle is in a state where the host vehicle is permitted to enter the intersection (i.e., permitted to start moving) in response to recognizing that the traffic signal located in front of the host vehicle has been switched to one of the arrow-signal indication states.

Let us describe an example where the traffic signal 50 has the configuration illustrated in FIG. 3.

In response to recognizing the traffic signal 50 has been switched to the indication pattern FIG. 3(a), the ECU 10 notifies, using the notifying device 33, that the host vehicle is permitted to move straight ahead or turn left at the intersection. Additionally, in response to recognizing the traffic signal 50 has been switched to the indication pattern FIG. 3(c), the ECU 10 notifies, using the notifying device 33, that the host vehicle is permitted to turn right at the intersection. For example, the notifying device 33 issues, by voice, such a notification indicative of a proceed permission of the host vehicle

In a state in which a host vehicle is stopped at an intersection, waiting for traffic signal located at the intersection to change, there may occur a temporary lost state in which the traffic signal is obscured by another vehicle after recognition of one of the arrow-signal indication states of the traffic signal. In such a case, when the temporary lost state of the traffic signal is resolved, an unnecessary notification indicating a proceed permission of the host vehicle may be issued. That is, as illustrated for example in FIG. 3, when the traffic signal has been switched to the indication pattern FIG. 3(c), a notification indicating a proceed permission of a vehicle waiting for right-turning is issued. Thereafter, when a temporary lost state of the traffic signal occurs and thereafter the indication pattern FIG. 3(c) is recognized again, an unnecessary notification indicating a proceed permission of a vehicle waiting for right-turning is issued again although the same notification has been already issued. This issuance of such an unnecessary notification indicating a proceed permission of the host vehicle may cause the driver to feel discomfort or a sense of incongruity.

In view of the above circumstances, the present embodiment makes it possible to prevent execution of such an unnecessary notification.

The following describes, in detail, how the ECU 10 determines whether to notify a proceed permission of the host vehicle in accordance with the signal indication state of the traffic signal 50 illustrated in FIGS. 2 and 3, which is located at a target intersection in front of the host vehicle as a recognition target thereof.

The ECU 10 includes, as illustrated in FIG. 1, a traffic signal recognizer 11, a signal indication state recognizer 12, a signal indication state determiner 13, a continuation determiner 14, and a driving assistance controller 15. The signal indication state determiner 13 and the continuation determiner 14 serve as, for example, a determiner of the present disclosure.

The traffic signal recognizer 11 executes a signal recognition process. Specifically, the signal recognition process, for example, acquires one or more images of a predetermined region located in front of the own vehicle captured by the camera 21. Then, the signal recognition process analyzes the captured images to accordingly determine, based on the analysis results, whether there is a target traffic signal 50 that is located in front of the host vehicle and governs the host vehicle's path. For example, known pattern matching between (i) template images stored in the storage 101 and (ii) the captured images can be used to determine whether there is a target traffic signal 50 located in front of the host vehicle.

The signal indication state recognizer 12 executes an indication state recognition process. Specifically, the indication state recognition process analyzes, for example, pixel values (e.g., color and luminance) in the target traffic signal's region included in the one or more captured images, and recognizes, based on the analysis results, the signal indication state of the target traffic signal 50.

In particular, the indication state recognition process of the signal indication state recognizer 12 recognizes, based on the analysis results, the signal indication state of the target traffic signal 50 corresponds to any one of the indication patterns FIG. 3(a) to FIG. 3(e). Additionally, the indication state recognition process of the signal indication state recognizer 12 recognizes, based on the analysis results, transition of the traffic signal 50 to one of the arrow-signal indication states including the red signal and an arrow signal.

The signal indication state determiner 13 determines, in response to new recognition of one of the arrow-signal indication states, which will be referred to as a current arrow-signal indication state of the traffic signal 50, whether the current arrow-signal indication state of the traffic signal 50 is identical to the immediately previous arrow-signal indication state. The immediately previous arrow-signal indication state triggered the immediately previous execution of one or more driving assistance processes, such as execution of a notification issuance process (see step S19 described later).

The continuation determiner 14 determines, in response to determination that the current arrow-signal indication state of the traffic signal 50 is identical to the immediately previous arrow-signal indication state, whether the immediately previous arrow-signal indication state of the traffic signal 50 has continued unchanged until the current arrow-signal indication state of the traffic signal 50.

Specifically, the continuation determiner 14 determines whether the continuation determiner 14 has recognized the yellow signal of the main signal unit 51 after transition of the traffic signal 50 to the immediately previous arrow-signal indication state. In the traffic signal 50, when an arrow signal indication state changes, the main signal unit 51 indicates the yellow signal between successive arrow-signal indication states. For this reason, upon determination that the continuation determiner 14 has not recognized the yellow signal of the main signal unit 51 after transition of the traffic signal 50 to the immediately previous arrow-signal indication state, the continuation determiner 14 determines that the immediately previous arrow-signal indication state of the traffic signal 50 has remained unchanged until the current arrow-signal indication state of the traffic signal 50.

The driving assistance controller 15 executes a notification process of controlling the notifying device 33 to cause the notifying device 33 to issue, by voice, a notification indicative of a proceed permission of the host vehicle in response to new recognition of the current arrow-signal indication state when it is determined that the current arrow-signal indication state of the traffic signal 50 is different from the immediately previous arrow-signal indication state.

Specifically, the driving assistance controller 15 controls the notifying device 33 to cause the notifying device 33 to issue, by voice, a notification indicative of a proceed permission of the host vehicle in response to recognition of the traffic-signal transition to the indication pattern FIG. 3(a) or the indication pattern FIG. 3(c) as long as the indication pattern FIG. 3(a) or the indication pattern FIG. 3(c) is different from the immediately previous indication pattern.

In contrast, the driving assistance controller 15 is configured to prevent execution of the notification process in response to new recognition of the current arrow-signal indication state when it is determined that the immediately previous arrow-signal indication state of the traffic signal 50 has continued unchanged until the current arrow-signal indication state of the traffic signal 50.

Because the proceed-permission notification based on the current arrow-signal indication state of the traffic signal 50 has been already issued, this configuration makes it possible to prevent execution of an unnecessary proceed-permission notification.

Alternatively, the driving assistance controller 15 may be configured to determine, in response to new recognition of the current arrow-signal indication state, whether to execute the notification process of controlling the notifying device 33 to cause the notifying device 33 to issue, by voice, a proceed-permission notification of the host vehicle in accordance with an elapsed time that has elapsed since execution of the immediately previous execution of one or more driving assistance processes, such as execution of a notification issuance process, triggered by transition to the immediately previous arrow-signal indication state of the traffic signal 50.

That is, the driving assistance controller 15 may be configured to start measuring an elapsed time since execution of each proceed-permission notification. Then, the driving assistance controller 15 may be configured to determine, in response to new recognition of the current arrow-signal indication state, whether the measured elapsed time since execution of the immediately previous proceed-permission notification is longer than or equal to a predetermined threshold time TH, such as approximately several tens of seconds to two minutes.

Specifically, even if it is determined that the current arrow-signal indication state of the traffic signal 50 is identical to the immediately previous arrow-signal indication state, the driving assistance controller 15 controls, in response to new recognition of the current arrow-signal indication state, the notifying device 33 to cause the notifying device 33 to issue, by voice, a notification indicative of a proceed permission of the host vehicle upon determination that the measured elapsed time since execution of the immediately previous proceed-permission notification is longer than or equal to the predetermined threshold time TH.

As described above, the driving assistance controller 15 executes the notification process of controlling the notifying device 33 to cause the notifying device 33 to issue, by voice, a notification indicative of a proceed permission of the host vehicle in response to new recognition of the current arrow-signal indication state when it is determined that the current arrow-signal indication state of the traffic signal 50 is different from the immediately previous arrow-signal indication state.

Next, the following describes how the ECU 10 controls notification of a proceed permission of the host vehicle in a case where a lost state of the traffic signal 50 occurs with reference to FIGS. 5A to 5C. In this case, while the red-signal and the right-turn arrow are displayed by the traffic signal 50 and the red-signal and the right-turn arrow are recognized, a lost state of the traffic signal 50 occurs. In each of FIGS. 5A to 5C, a period during which the lost state of the traffic signal 50 occurs is indicated by a rectangular frame denoted by reference character LS. That is, the period during which the lost state of the traffic signal 50 occurs will also be referred to as a traffic-signal lost period LS.

FIG. 5A shows a situation (i.e., a scene) where, immediately after the lost state of the traffic signal 50 occurs while the red-signal and the right-turn are being recognized, the red-signal and the right-turn arrow, which are the same as those before the occurrence of the lost state of the traffic signal 50, are newly recognized. In this situation, it is determined that the immediately previous arrow-signal indication state of the traffic signal 50 has continued unchanged until the current arrow-signal indication state of the traffic signal 50 as long as the yellow signal of the main signal unit 51 has not been recognized after transition of the traffic signal 50 to the immediately previous arrow-signal indication state.

In this situation illustrated in FIG. 5A, it is expected that a proceed-permission notification of the host vehicle has been issued, and the present embodiment is configured not to issue an additional proceed-permission notification, making it therefore possible to prevent issuance of an unnecessary proceed-permission notification.

Let us assume that an elapsed time that has elapsed since transition of the traffic signal 50 to the immediately previous arrow-signal indication state (i.e., since execution of the immediately previous proceed-permission notification) exceeds the predetermined threshold time TH. In this assumption, even if the current arrow-signal indication state, which is identical to the immediately previous arrow-signal indication state, is newly recognized, there may be not a situation where the immediately previous arrow-signal indication state has continued unchanged during the traffic-signal lost period LS but a situation where, after a full cycle of the signal indication states of the traffic signal 50 has been completed, a new current arrow-signal indication state of the traffic signal 50, which is identical to the immediately previous arrow-signal indication state thereof, is recognized.

For this reason, even if the current arrow-signal indication state, which is identical to the immediately previous arrow-signal indication state, is newly recognized, the present embodiment is configured to execute issuance of a proceed permission notification as long as the elapsed time that has elapsed since transition of the traffic signal 50 to the immediately previous arrow-signal indication state exceeds the predetermined threshold time TH. That is, in a case where the elapsed time that has elapsed since transition of the traffic signal 50 to the immediately previous arrow-signal indication state is longer than or equal to the predetermined threshold time TH, the present embodiment makes it possible to reduce the likelihood that the driver of the host vehicle experiences discomfort even if a repeated proceed-permission notification is issued while the host vehicle is in a signal-waiting state.

FIG. 5B shows a situation where the traffic signal 50 is switched to a new arrow-signal indication state, which differs from the immediately previous arrow-signal indication state, in response to the lost state of the traffic signal 50 being resolved, so that the new arrow-signal indication state of the traffic signal 50 is recognized. In this situation, because it is determined that transition of the traffic signal 50 to the new arrow-signal indication state has occurred after recognition of the immediately previous arrow-signal indication state, the present embodiment is configured to issue a proceed-permission notification based on the new arrow-signal indication state.

FIG. 5C shows a situation where the yellow signal of the traffic signal 50 is displayed after the lost state of the traffic signal 50 is resolved, and thereafter the traffic signal 50 is switched to a current arrow-signal indication state, which is the same as the immediately previous arrow-signal indication state including the red signal and the right-turn arrow, so that the current arrow-signal indication state of the traffic signal 50 is newly recognized. In this situation, because the yellow signal of the main signal unit 51 after transition of the traffic signal 50 to the immediately previous arrow-signal indication state is recognized, the present embodiment is configured to issue a proceed-permission notification based on the current arrow-signal indication state at the timing when the traffic signal 50 is switched to the current arrow-signal indication state including the red signal and the right-turn arrow.

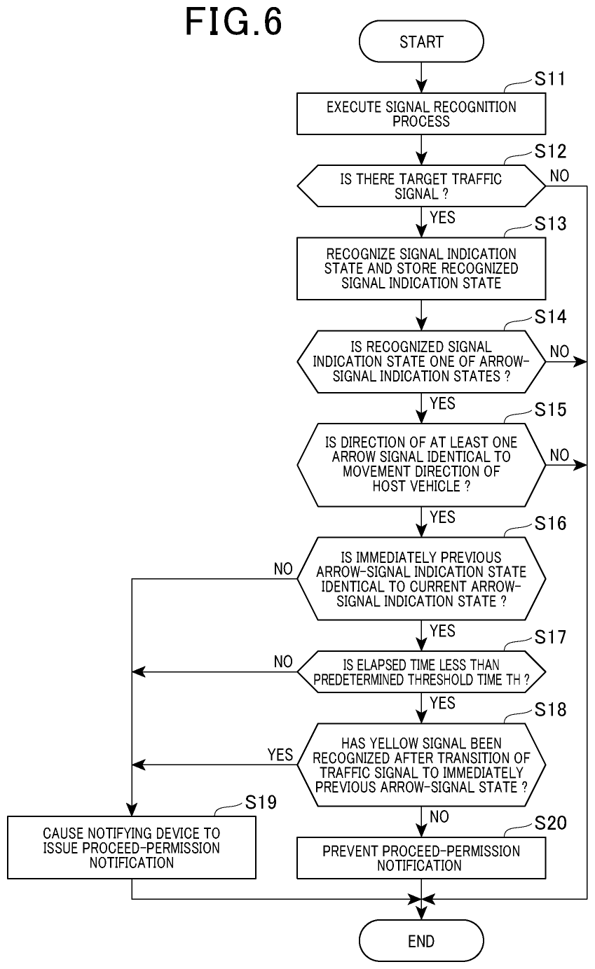

FIG. 6 is a flowchart illustrating a driving-assistance control routine related to the driving assistance control of the host vehicle. The processor 100 of the ECU 10 is configured to cyclically execute the driving-assistance control routine at predetermined intervals.

When starting a current cycle of the driving-assistance control routine, the processor 100 serves as, for example, the traffic signal recognizer 11 to execute the signal recognition process set forth above, for recognizing, based on one or more captured images from the camera 21, a target traffic signal 50 installed at a target intersection in front of the host vehicle; the target traffic signal 50 governs the host vehicle's path in step S11.

Then, the processor 100 serves as, for example, the traffic signal recognizer 11 to determine, based on the analysis results of the captured images by the signal recognition process, whether there is a target traffic signal 50 that is located in front of the host vehicle and governs the host vehicle's path in step S12.

Upon determining that there is not a target traffic signal 50 that is located in front of the host vehicle and governs the host vehicle's path (NO in step S12), the processor 100 terminates the current cycle of the driving-assistance control routine.

Otherwise, upon determination that there is a target traffic signal 50 that is located in front of the host vehicle and governs the host vehicle's path (YES in step S12), the current cycle of the driving-assistance control routine proceeds to step S13.

In step S13, the processor 100 serves as, for example, the signal indication state recognizer 12 executes the indication state recognition process set forth above to recognize the signal indication state of the target traffic signal 50 corresponds to any one of the indication patterns FIG. 3(a) to FIG. 3(e) illustrated in FIG. 3, and stores the recognized signal indication state of the target traffic signal 50 in, for example, the RAM of the storage 101.

Following the operation in step S13, the processor 100 serves as, for example, the signal indication state determiner 13 to determine whether the recognized signal indication state (i.e., one of the indication patterns FIG. 3(a) to FIG. 3(e)) is one of the arrow-signal indication states (i.e., one of the indication patterns FIG. 3(a) and FIG. 3(c)) in step S14.

Upon determining that the recognized signal indication state is not one of the arrow-signal indication states (NO in step S14), the processor 100 terminates the current cycle of the driving-assistance control routine.

Otherwise, upon determining that the recognized signal indication state i one of the arrow-signal indication states (YES in step S14), the processor 100 serves as, for example, the signal indication state determiner 13 to determine whether the direction of at least one arrow signal included in the one of the arrow-signal indication states (i.e., the current arrow-signal indication state) of the traffic signal 50 is identical to the movement direction of the host vehicle in step S15. In step S15, the processor 100 starts measuring an elapsed time in response to determination that the traffic signal 50 is in an arrow-signal switching timing.

For example, let us assume that one of the indication patterns FIG. 3(a) to FIG. 3(e) recognized in step S13 is the arrow-signal indication state (indication pattern) FIG. 3(a).

In this assumption, when the movement direction of the host vehicle is straight or a left turn, the processor 100 determines that the direction of at least one arrow signal included in the current arrow-signal indication state of the traffic signal 50 is identical to the movement direction of the host vehicle (YES in step S15). Then, the current cycle of the driving-assistance control routine proceeds to step S16. Otherwise, when the movement direction of the host vehicle is a right turn, the processor 100 determines that the direction of at least one arrow signal included in the current arrow-signal indication state of the traffic signal 50 is different from the movement direction of the host vehicle (NO in step S15). Then, the processor 100 terminates the current cycle of the driving-assistance control routine.

As another example, let us assume that one of the indication patterns FIG. 3(a) to FIG. 3(e) recognized in step S13 is the arrow-signal indication state (indication pattern) FIG. 3(c).

In this assumption, when the movement direction of the host vehicle is a right turn, the processor 100 determines that the direction of at least one arrow signal included in the current arrow-signal indication state of the traffic signal 50 is identical to the movement direction of the host vehicle (YES in step S15). Then, the current cycle of the driving-assistance control routine proceeds to step S16.

Otherwise, when the movement direction of the host vehicle is a straight or a left turn, the processor 100 determines that the direction of at least one arrow signal included in the current arrow-signal indication state of the traffic signal 50 is different from the movement direction of the host vehicle (NO in step S15). Then, the processor 100 terminates the current cycle of the driving-assistance control routine.

In step S16, the processor 100 serves as, for example, the continuation determiner 14 to determine whether the immediately previous arrow-signal indication state of the traffic signal 50, which has been stored in the storage 101, is identical to the current arrow-signal indication state of the traffic signal 50, which has been stored in the storage 101 in the current cycle of the driving-assistance control routine.

Upon determination that the immediately previous arrow-signal indication state of the traffic signal 50 is different from the current arrow-signal indication state of the traffic signal 50 (NO in step S16), the current cycle of the driving-assistance control routine proceeds to step S19.

Otherwise, upon determination that the immediately previous arrow-signal indication state of the traffic signal 50 is identical to the current arrow-signal indication state of the traffic signal 50 (YES in step S16), the current cycle of the driving-assistance control routine proceeds to step S17.

In step S17, the processor 100 serves as, for example, the continuation determiner 14 to determine whether the elapsed time that has elapsed since transition of the traffic signal 50 to the immediately previous arrow-signal indication state is less than the predetermined threshold time TH.

Upon determination that the elapsed time that has elapsed since transition of the traffic signal 50 to the immediately previous arrow-signal indication state is more than or equal to the predetermined threshold time TH (NO in step S17), the current cycle of the driving-assistance control routine proceeds to step S19.

Otherwise, upon determination that the elapsed time that has elapsed since transition of the traffic signal 50 to the immediately previous arrow-signal indication state is less than the predetermined threshold time TH (YES in step S17), the current cycle of the driving-assistance control routine proceeds to step S18.

In step S19, the processor 100 serves as, for example, the driving assistance controller 15 to cause the notifying device 33 to issue, by voice, a notification indicative of a proceed permission of the host vehicle based on the current arrow-signal indication state currently recognized thereby. This results in a voice notification message “Proceed straight or turn left” or “Turn right” being output from the notifying device 33. After the operation in step S19, the processor 100 terminates the current cycle of the driving-assistance control routine.

In step S18, the processor 100 serves as, for example, the continuation determiner 14 to determine whether the continuation determiner 14 has recognized the yellow signal of the main signal unit 51 after transition of the traffic signal 50 to the immediately previous arrow-signal indication state.

Upon determining that the continuation determiner 14 has recognized the yellow signal of the main signal unit 51 after transition of the traffic signal 50 to the immediately previous arrow-signal indication state (YES in step S18), the processor 100 determines that the immediately previous arrow-signal indication state of the traffic signal 50 has not continued to the current arrow-signal indication state. Then, the processor 100 causes, in step S19, the notifying device 33 to issue, by voice, a notification indicative of a proceed permission of the host vehicle based on the current arrow-signal indication state currently recognized thereby. After the operation in step S19, the processor 100 terminates the current cycle of the driving-assistance control routine.

Otherwise, upon determining that the continuation determiner 14 has not recognized the yellow signal of the main signal unit 51 after transition of the traffic signal 50 to the immediately previous arrow-signal indication state (NO in step S18), the processor 100 determines that the immediately previous arrow-signal indication state of the traffic signal 50 has continued to the current arrow-signal indication state. Then, the processor 100 serves as, for example, the driving assistance controller 15 to prevent a proceed-permission notification in step S20. Specifically, the processor 100 serves as, for example, the driving assistance controller 15 to determine, in step S20, not to cause the notifying device 33 to issue a notification indicative of a proceed permission of the host vehicle. After the operation in step S20, the processor 100 terminates the current cycle of the driving-assistance control routine.

Note that the processor 100 may be configured to measure the elapsed time in response to execution of a proceed-permission notification in step S19 based on the immediately previous arrow-signal indication state of the traffic signal 50.

The present embodiment described above achieves the following beneficial effects.

The ECU 10 of the present embodiment is configured to determine, in response to new recognition of a current arrow-signal indication state, whether an immediately previous arrow-signal indication state at which a proceed-permission notification has been executed is identical to the current arrow-signal indication state. The ECU 10 of the present embodiment is configured to determine, in response to determination that the immediately previous arrow-signal indication state is identical to the current arrow-signal indication state, whether the immediately previous arrow-signal indication state of the traffic signal 50 has continued to the current arrow-signal indication state.

Upon determining, in response to determination that the immediately previous arrow-signal indication state is identical to the current arrow-signal indication state, that the immediately previous arrow-signal indication state of the traffic signal 50 has continued to the current arrow-signal indication state, the ECU 10 of the present embodiment is additionally configured to prevent execution of a notification indicative of a proceed permission of the host vehicle.

This configuration of the ECU 10 prevents execution of an unnecessary proceed-permission notification at an intersection, making it possible to appropriately execute the driving assistance of the host vehicle.

The ECU 10 of the present embodiment is configured to determine whether the ECU 10 has recognized the yellow signal of the main signal unit 51 after transition of the traffic signal 50 to the immediately previous arrow-signal indication state, and determine that the immediately previous arrow-signal indication state of the traffic signal 50 has continued to the current arrow-signal indication state in response to determining that the ECU 10 has not recognized the yellow signal of the main signal unit 51 after transition of the traffic signal 50 to the immediately previous arrow-signal indication state.

Specifically, in the traffic signal 50, when an arrow signal indication state changes, the main signal unit 51 indicates the yellow signal between successive arrow-signal indication states. For this reason, upon determination that the ECU 10 has not recognized the yellow signal of the main signal unit 51 after transition of the traffic signal 50 to the immediately previous arrow-signal indication state, the ECU 10 determines that the immediately previous arrow-signal indication state of the traffic signal 50 has remained unchanged until the current arrow-signal indication state of the traffic signal 50. This therefore makes it possible to appropriately control the issuance of a proceed-permission notification.

The ECU 10 is configured to execute, as a driving assistance process, a notification indicative of a situation where the host vehicle is permitted to proceed in response to recognizing transition of the traffic signal 50 to an arrow-signal indication state. This configuration makes it possible to, when the host vehicle is about to travel through an intersection at which the traffic signal 50 is installed, execute an appropriate proceed-permission notification to the host vehicle without repeated unnecessary proceed-permission notifications.

The ECU 10 of the present embodiment is configured to determine, in response to determination that the immediately previous arrow-signal indication state is identical to the current arrow-signal indication state, whether the elapsed time that has elapsed since transition of the traffic signal 50 to the immediately previous arrow-signal indication state is less than the predetermined threshold time TH.

Then, upon determining, in response to determination that the immediately previous arrow-signal indication state is identical to the current arrow-signal indication state, that the elapsed time that has elapsed since transition of the traffic signal 50 to the immediately previous arrow-signal indication state is longer than or equal to the predetermined threshold time TH, the ECU 10 of the present embodiment is configured to execute a notification indicative of a proceed permission of the host vehicle based on the current arrow-signal indication state.

Specifically, let us consider a situation where the elapsed time that has elapsed since transition of the traffic signal 50 to the immediately previous arrow-signal indication state is longer than or equal to the predetermined threshold time TH. In this situation, even if the ECU 10 has not recognized the yellow signal of the main signal unit 51 after transition of the traffic signal 50 to the immediately previous arrow-signal indication state, the yellow signal of the main signal unit 51 is likely to be displayed under a condition where the yellow signal is not recognized by the ECU 10 of the host vehicle. For this reason, this configuration of the ECU 10 makes it possible to reliably execute a notification signifying the host vehicle is permitted to proceed based on the current arrow-signal indication state after illumination of the yellow signal.

Upon determining, in response to new recognition of a current arrow-signal indication state, that the immediately previous arrow-signal indication state is different from the current arrow-signal indication state, the ECU 10 of the present embodiment is configured to execute a notification indicative of a proceed permission of the host vehicle based on the current arrow-signal indication state.

This makes it possible to properly determine, under a situation where a temporary lost state of the traffic signal 50 may occur, whether to execute a proceed-permission notification based on a new recognition of the current arrow-signal indication state, thus properly issuing a proceed-permission notification of the host vehicle.

### Modifications

The present embodiment may be modified as follows:

The continuation determiner 14 may be configured execute, as a process of determining, in response to determination that the current arrow-signal indication state of the traffic signal 50 is identical to the immediately previous arrow-signal indication state, whether the immediately previous arrow-signal indication state of the traffic signal 50 has continued unchanged until the current arrow-signal indication state of the traffic signal 50, a process of determining whether the red signal of the main signal unit 51 has been continuously recognized after transition of the traffic signal 50 to the immediately previous arrow-signal indication state. That is, after transition of the traffic signal 50 to the immediately previous arrow-signal indication state, only recognition of the arrow signal unit 52 may be lost.

In this case, the signal indication state of the main signal unit 51 can be continuously recognized. For this reason, immediately after the lost state of the traffic signal 50 is resolved, when determining that the red signal of the main signal unit 51 has been continuously recognized, the ECU 10 makes it possible to determine that the immediately previous arrow-signal indication state of the traffic signal 50 has continued unchanged until the current arrow-signal indication state of the traffic signal 50.

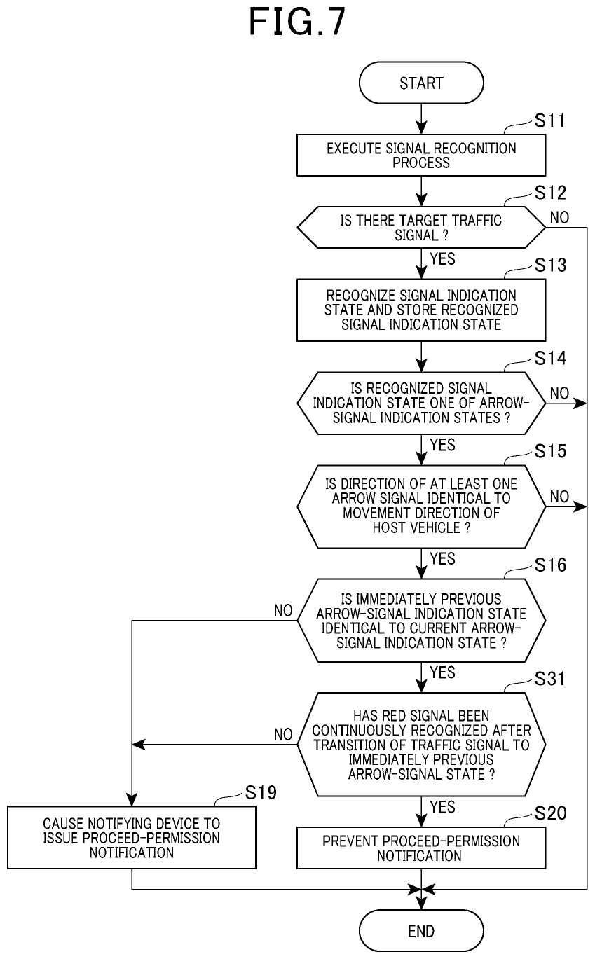

The processor 100 of the ECU 10 according to this medication may be configured to execute a driving-assistance control routine illustrated in FIG. 7 in place of that illustrated in FIG. 6. A part of the driving-assistance control routine illustrated in FIG. 6 has been modified to create the driving-assistance control routine illustrated in FIG. 7. In FIG. 7, the same step numbers are assigned to operations identical to those illustrated in FIG. 6.

Upon determination that the immediately previous arrow-signal indication state of the traffic signal 50 is identical to the current arrow-signal indication state of the traffic signal 50 (YES in step S16), the current cycle of the driving-assistance control routine illustrated in FIG. 7 proceeds to step S31.

In step S31, the processor 100 serves as, for example, the continuation determiner 14 to determine whether the red signal of the main signal unit 51 has been continuously recognized after transition of the traffic signal 50 to the immediately previous arrow-signal indication state.

For example, in response to determining that, after transition of the traffic signal 50 to the indication pattern FIG. 3(a) or FIG. 3(c) as the immediately previous arrow-signal indication state, the red signal of the main signal unit 51 has been continuously recognized (YES in step S31), the processor 100 makes it possible to determine that the immediately previous arrow-signal indication state of the traffic signal 50 has continued unchanged until the current arrow-signal indication state of the traffic signal 50. Then, the processor 100 serves as, for example, the driving assistance controller 15 to determine, in step S20, to prevent the notifying device 33 from issuing, by voice, a notification indicative of a proceed permission of the host vehicle. After the operation in step S20, the processor 100 terminates the current cycle of the driving-assistance control routine.

Otherwise, in response to determining that the red signal of the main signal unit 51 has not been continuously recognized after transition of the traffic signal 50 to the immediately previous arrow-signal indication state (NO in step S31), the processor 100 serves as, for example, the driving assistance controller 15 to cause the notifying device 33 to issue, by voice, a proceed-permission notification of the host vehicle based on the current arrow-signal indication state in step S19. After the operation in step S19, the processor 100 terminates the current cycle of the driving-assistance control routine.

Note that the driving-assistance control routine illustrated in FIG. 7 is designed such that the operations in steps S17 and S18 of the driving-assistance control routine illustrated in FIG. 6 are changed to the operation in step S31. In this modification, the processor 100 may be configured to execute at least one of the operations in steps S17 and S18 illustrated in FIG. 6 and the operation in step S31 illustrated in FIG. 7.

Specifically, as described above, in the traffic signal 50, when an arrow signal indication state changes, the red signal displayed by the main signal unit 51 is switched to another color signal, such as the yellow signal. For this reason, upon determining that the red signal of the main signal unit 51 has been continuously recognized after transition of the traffic signal 50 to the immediately previous arrow-signal indication state, the processor 100 makes it possible to determine that the immediately previous arrow-signal indication state of the traffic signal 50 has continued unchanged until the current arrow-signal indication state of the traffic signal 50. This therefore enables appropriate control of the issuance of a proceed-permission notification.

The processor 100 may be configured to determine, as the process of determining whether the immediately previous arrow-signal indication state of the traffic signal 50 has continued to the current arrow-signal indication state, whether the elapsed time that has elapsed since transition of the traffic signal 50 to the immediately previous arrow-signal indication state is less than a predetermined time, such as 30 seconds. In this modification, in response to determination that the elapsed time that has elapsed since transition of the traffic signal 50 to the immediately previous arrow-signal indication state is less than the predetermined time, the processor 100 makes it possible to determine that the immediately previous arrow-signal indication state of the traffic signal 50 has continued to the current arrow-signal indication state.

Intersections have various configurations, and a duration of at least one arrow-signal indication state in a traffic signal differs depending on the corresponding intersection at which the traffic signal is installed. For example, a traffic signal installed at an intersection where two roads intersect, and each road has a large number of lanes has a longer duration of at least one arrow-signal indication state than that installed at an intersection having a smaller number of lanes. Moreover, a traffic signal installed at an intersection where multiple lanes are provided in the same arrow direction (for example, multiple right-turn lanes) has a longer duration of the corresponding arrow-signal indication state than that installed at an intersection where only a single lane is provided in the same arrow direction.

From this viewpoint, the continuation determiner 14 may be configured to variably set the predetermined time TH for determining the elapsed time that has elapsed since transition of the traffic signal 50 to the immediately previous arrow-signal indication state in accordance with information related to the configuration of an intersection at which the target traffic signal is installed.

Specifically, in step S17 of FIG. 6, the processor 100 of the ECU 10 may acquire, from, for example, a navigation system NS (see a block shown by phantom lines in FIG. 1), map information including (i) information indicating the total number of lanes at the target intersection, (ii) information indicating the number of right-turn lanes, and/or other traffic information related to the target intersection. Then, the processor 100 of the ECU 10 may set the predetermined threshold time TH based on the acquired information. In this modification, the greater the number of lanes of each road intersecting at the target intersection, the longer the predetermined time TH may be set by the processor 100 of the ECU 10.

Alternatively, the greater the number of lanes in the same arrow direction at the target intersection, the longer the predetermined time TH may be set by the processor 100 of the ECU 10.

Then, the processor 100 of the ECU 10 may determine, in step S17, whether the elapsed time that has elapsed since transition of the traffic signal 50 to the immediately previous arrow-signal indication state is less than the predetermined threshold time TH. This modification makes it possible to issue a more appropriate proceed-permission notification for the host vehicle when the host vehicle travels in accordance with an arrow signal of the target traffic signal.

The traffic signal 50 is not limited to the configurations shown in FIGS. 2 to 4, and may have one of other configurations. For example, the traffic signal 50 may have a configuration in which the left-turn arrow signal unit 71 and the straight-ahead arrow signal unit 72 are only provided as the arrow signal unit 52 or may have a configuration in which the left-turn arrow signal unit 71 is only provided as the arrow signal unit 52. Further, the traffic signal 50 may have a configuration in which the lamp units of the respective colors (green, yellow, red) of the main signal unit 51 are arranged vertically.

If a target traffic signal installed at a target intersection and located in front of the host vehicle is configured to have only one arrow-signal indication state (see FIG. 4), the processor 100 of the ECU 10 is configured to always affirm the determination in step S16, because the immediately previous arrow-signal indication state of the target traffic signal is always identical to the current arrow-signal indication state.

The driving assistance process of the host vehicle 10 executed by the ECU 10 is not limited to the process of causing the notifying device 33 to issue, by voice, a proceed-permission notification, and the ECU 10 may be configured to execute other driving assistance processes of the host vehicle 10. For example, the ECU 10 may be configured to cause the notifying device 33 to issue, on the display device, a proceed-permission notification. Alternatively or additionally, the ECU 10 may be configured to control the accelerator device 31 to cause the host vehicle to automatically start based on recognition of the current arrow-signal indication state of the traffic signal 50.

The ECU 10 and the methods carried out thereby described in the present disclosure may be implemented by a dedicated computer provided so as to include a processor, which has been programmed to execute one or a plurality of functions (commands) embodied by a computer program, and a memory.

Alternatively, the ECU 10 and the methods carried out thereby described in the present disclosure may be implemented by a dedicated computer provided so as to include a processor formed of one or more dedicated hardware logic circuits. Alternatively, the ECU 10 and the methods carried out thereby described in the present disclosure may be implemented by one or more dedicated computers configured to include a combination of a processor, which has been programmed to execute one or a plurality of functions, and a memory, with a processor formed of one or more hardware logic circuits. The computer program may be, as an instruction to be executed by a computer, stored in a computer-readable non-transitory tangible memory medium.

The present disclosure has been described in accordance with the examples, but is to be understood not to be limited to the examples and the structures thereof. The present disclosure embraces various modified examples and modifications within the range of equivalency. Further, various combinations and forms, and other combinations and forms including only one more element, or more or less than one element in addition thereto are also within the spirit and scope of the present disclosure.

1. A driving assistance apparatus of a host vehicle in response to a traffic signal that is located in front of the host vehicle and includes a main signal unit and an arrow signal unit, the driving assistance apparatus comprising:
a driving assistance controller configured to execute a driving assistance process of the host vehicle in response to recognizing a transition of the traffic signal to an arrow-signal indication state that includes a red signal and an arrow signal; and
a determiner configured to determine, in response to new recognition of a current arrow-signal indication state of the traffic signal after execution of the driving assistance process, whether the arrow-signal indication state related to execution of the driving assistance process has continued unchanged in the current arrow-signal indication state,
the driving assistance controller being configured to prevent execution of the driving assistance process of the host vehicle in response to the new recognition of the current arrow-signal indication state upon determination that the arrow-signal indication state related to execution of the driving assistance process has continued unchanged in the current arrow-signal indication state.

2. The driving assistance apparatus according to claim 1, wherein:
the arrow-signal indication state includes a first arrow-signal indication state and a second arrow-signal indication state that is different from the first arrow-signal indication state;
the determiner is configured to determine, in response to new recognition of the current arrow-signal indication state of the traffic signal after execution of the driving assistance process, whether the arrow-signal indication state related to execution of the driving assistance process is identical to the current arrow-signal indication state; and
the driving assistance controller is configured to disable execution of the driving assistance process of the host vehicle in response to the new recognition of the current arrow-signal indication state upon determination that:
(i) the arrow-signal indication state related to execution of the driving assistance process is identical to the current arrow-signal indication state; and
(ii) the arrow-signal indication state related to execution of the driving assistance process has continued unchanged in the current arrow-signal indication state.

3. The driving assistance apparatus according to claim 1, wherein:
the determiner is configured to:
determine whether a yellow signal of the traffic signal is recognized after transition of the traffic signal to the arrow-signal indication state related to execution of the driving assistance process; and
determine that the arrow-signal indication state related to execution of the driving assistance process has continued unchanged in the current arrow-signal indication state upon determination that the yellow signal of the traffic signal is not recognized after transition of the traffic signal to the arrow-signal indication state related to execution of the driving assistance process.

4. The driving assistance apparatus according to claim 1, wherein:
the determiner is configured to:
determine whether the red signal of the traffic signal has been continuously recognized after transition of the traffic signal to the arrow-signal indication state related to execution of the driving assistance process; and
determine that the arrow-signal indication state related to execution of the driving assistance process has continued unchanged in the current arrow-signal indication state upon determination that the red signal of the traffic signal has been continuously recognized after transition of the traffic signal to the arrow-signal indication state related to execution of the driving assistance process.

5. The driving assistance apparatus according to claim 1, wherein:
the driving assistance controller is configured to execute, as the driving assistance process of the host vehicle, a proceed-permission notification of the host vehicle in response to recognizing the transition of the traffic signal to the arrow-signal indication state.

6. The driving assistance apparatus according to claim 2, wherein:
the determiner is configured to determine, in response to new recognition of the current arrow-signal indication state of the traffic signal after execution of the driving assistance process, whether an elapsed time that has elapsed since execution of the driving assistance process is longer than or equal to a predetermined threshold time; and
the driving assist controller is configured to execute the driving assistance process of the host vehicle in response to the new recognition of the current arrow-signal indication state upon determination that:
(i) the arrow-signal indication state related to execution of the driving assistance process is identical to the current arrow-signal indication state; and
(ii) the elapsed time that has elapsed since execution of the driving assistance process is longer than or equal to the predetermined threshold time.

7. The driving assistance apparatus according to claim 6, wherein:
the driving assistance controller is configured to set the predetermined threshold time in accordance with information on a configuration of the traffic signal.

8. The driving assistance apparatus according to claim 1, wherein:
the driving assist controller is configured to execute the driving assistance process of the host vehicle in response to the new recognition of the current arrow-signal indication state upon determination that the arrow-signal indication state related to execution of the driving assistance process has not continued unchanged in the current arrow-signal indication state.

9. A program product for driving assistance for a host vehicle in response to a traffic signal that is located in front of the host vehicle and includes a main signal unit and an arrow signal unit, the program product comprising:
a non-transitory storage medium; and
computer-program instructions stored in the non-transitory storage medium,
the computer-program instructions causing a processor to:
execute a driving assistance process of the host vehicle in response to recognizing a transition of the traffic signal to an arrow-signal indication state that includes a red signal and an arrow signal;
determine, in response to new recognition of a current arrow-signal indication state of the traffic signal after execution of the driving assistance process, whether the arrow-signal indication state related to execution of the driving assistance process has continued unchanged in the current arrow-signal indication state; and
prevent execution of the driving assistance process of the host vehicle in response to the new recognition of the current arrow-signal indication state upon determination that the arrow-signal indication state related to execution of the driving assistance process has continued unchanged in the current arrow-signal indication state.

10. A driving assistance method for a host vehicle in response to a traffic signal that is located in front of the host vehicle and includes a main signal unit and an arrow signal unit, the driving assistance method comprising:
executing a driving assistance process of the host vehicle in response to recognizing a transition of the traffic signal to an arrow-signal indication state that includes a red signal and an arrow signal;
determining, in response to new recognition of a current arrow-signal indication state of the traffic signal after execution of the driving assistance process, whether the arrow-signal indication state related to execution of the driving assistance process has continued unchanged in the current arrow-signal indication state; and
preventing execution of the driving assistance process of the host vehicle in response to the new recognition of the current arrow-signal indication state upon determination that the arrow-signal indication state related to execution of the driving assistance process has continued unchanged in the current arrow-signal indication state.
